(19) United States
(12) Patent Application Publication
(10) Pub. No.: US 2016/0117447 A1
(43) Pub. Date: Apr. 28, 2016

(54) METHOD OF MANAGING MEDICAL INFORMATION, APPARATUS OF PERFORMING THE SAME AND STORAGE MEDIUM STORING THE SAME

(71) Applicant: LG CNS CO., LTD., Seoul (KR)

(72) Inventors: Bum Seock LEE, Seoul (KR); Eun Hye Park, Seoul (KR); Soo Joung Cha, Seoul (KR); Eun Hee Kim, Seoul (KR); Kyoung Sun Park, Seoul (KR)

(21) Appl. No.: 14/523,394

(22) Filed: Oct. 24, 2014

(51) Int. Cl. G06F 19/00; G06Q 50/24

(52) U.S. Cl. CPC G06F 19/322; G06Q 50/24

(57) ABSTRACT

A method of managing medical information may include receiving, from a user, and registering an association between at least one item being included in each of a plurality of medical record charts, a first item in a first medical record chart and a second item in a second medical chart being independent from each other. The method may also include receiving a request for an access for a first medical record chart from the user and checking (or determining) whether at least one second item associated with at least one first item in the first medical record chart exists, the at least one second item being included in the plurality of the medical record charts.

### BACKGROUND

Embodiments may relate to a medical information management technology. More particularly, embodiments may relate to a method of managing medical information, an apparatus of performing the same and a storage medium storing the same. Embodiments may minimize a redundant input for a same item based on an association between items inputted in a medical record chart, and automatically inputting a content in a writing item of a care plan.

When a variety of medical information is generated and a variety of medical records is written on treating a patient in a medical institution, the generated medical information and the written medical record have an association and dependency and the association and dependency is a function of important information and a record for treating the patient. That is, when a matching and association of the medical information and medical record of the patient has an error, erroneous information may be provided to a medical team, and in a process solving such problem, an efficiency may be decreased, a suitable treatment may be performed and/or a medical accident may occur.

Korean Patent Registration No. 10-0580661, the subject matter of which is incorporated herein by reference, relates a system and method for sharing/utilizing personal medical information. The system and method may communicate a medical record between a medical institution and personal communication device, and may cause the medical institution and a related institution to be connected to share and use the medical information (including personal medical information). A person may manage a personal medical history and analyze a validity of the medical information to provide a personal medical record to another medical institution when necessary.

Korean Patent Registration No. 10-0594938, the subject matter of which is incorporated herein by reference, relates a system of providing medical information and a method of providing information. The system may cause a user to request personal medical information for medical information of a personal checkup and prescription record being managed in each medical institution by various type to receive the user's own medical information from a corresponding medical institution and to easily manage and transfer the medical information provided from the medical institution on a user's own risk to receive various value-added medical information service.

### BRIEF DESCRIPTION OF THE DRAWINGS

Arrangements and/or embodiments may be described in detail with reference to the following drawings in which like reference numerals refer to like elements and wherein:

FIG. 1 is a block diagram of a medical information management system;

FIG. 2 is a block diagram of a medical information management apparatus;

FIG. 3 is a diagram of a hardware configuration for a medical information management apparatus and a database server;

FIG. 4 is a flow chart showing a method of managing medical information being performed by the medical information management system of FIG. 1;

FIGS. 5A and 5B and FIGS. 6A and 6B are example diagrams showing examples where a value is automatically inputted in an item of a medical record chart; and

FIGS. 7A, 7B, and 7C are example diagrams showing a care plan being automatically generated.

### DETAILED DESCRIPTION

Explanation of embodiments is merely an embodiment for structural or functional explanation, so the scope of embodiments should not be construed to be limited to the explained embodiments. That is, since embodiments may be implemented in several forms without departing from characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second” etc., may be used to describe various components, such components must not be understood as being limited to the above terms. The above terms may be used to distinguish one component from another component. For example, a first component may be referred to as a second component without departing from the scope of rights of embodiments, and likewise a second component may be referred to as a first component.

It may be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps or operations are used for the sake of explanation and do not describe any particular order. The respective operations may be changed from a mentioned order unless specifically mentioned in context. Namely, respective steps may be performed in the same order as described, may be substantially simultaneously performed, and/or may be performed in reverse order.

Embodiments may be implemented as machine-readable codes on a machine-readable medium. The machine-readable medium may include any type of recording device for storing machine-readable data. Examples of the machine-readable recording medium may include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems that store and execute machine-readable codes in a de-centralized manner.

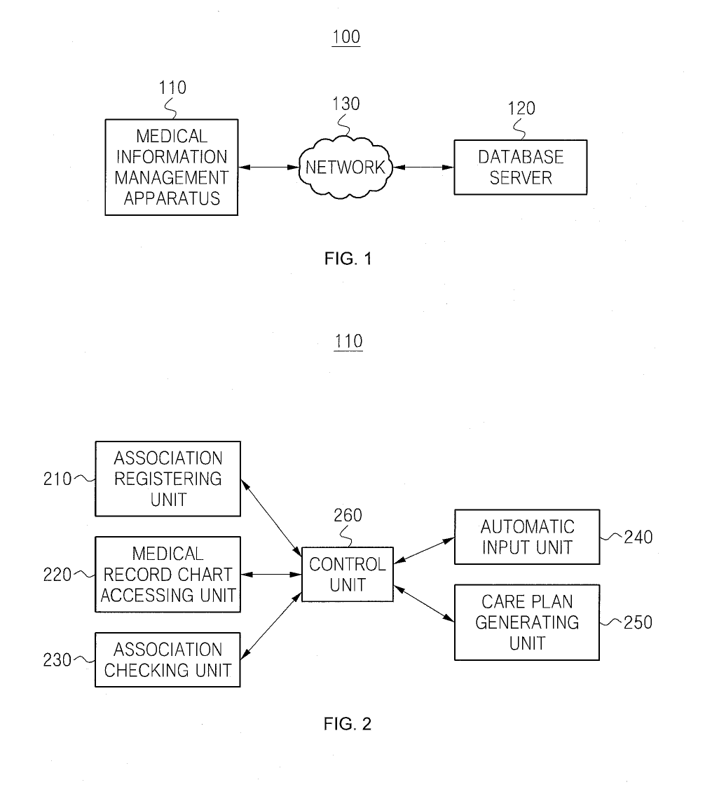

The terms used in the present disclosure are merely used to describe particular embodiments, and are not intended to limit the embodiments. Unless otherwise defined, all terms used herein, including technical or scientific terms, have the same meanings as those generally understood by those with ordinary knowledge in the field of art to which the embodiments belong. Such terms as those defined in a generally used dictionary are to be interpreted to have the meanings equal to the contextual meanings in the relevant field of art, and are not to be interpreted to have ideal or excessively formal meanings unless clearly defined in the present application.
FIG. 1 is a block diagram of a medical information management system. Other embodiments and configurations may also be provided.

Referring to FIG. 1, a medical information management system 100 may include a medical information management apparatus 110, a database server 120 and a network 130. The medical information management apparatus 110 may be linked with the database server 120 through the network 130.

The medical information management apparatus 110 may correspond to a device being linked with the database server 120 to execute a specific operation. The specific operation may correspond to a process being controlled by a user. In at least one embodiment, the medical information management apparatus 110 may be used for detecting specific information from the database server 120, and may be linked with a user terminal to receive the specific information from the user terminal. The user terminal may correspond to a computing device that is interlinked with the medical information management apparatus 110 to perform a medical information management method. For example, the user terminal may correspond to a desktop, a laptop, a smart phone and/or a tablet PC.

The database server 120 may manage at least one database, and the at least one database may manage necessary information for generating (or providing) a medical record chart. For example, each of the at least one database may store and manage patient information, charge information, medical treatment information and/or user information.

In at least one embodiment, the database server 120 may include a plurality of databases and each of the plurality of databases may correspond to an item master, a medical record chart template master, a care plan trigger master and a medical data storage. The item master may store and manage items being included in the medical record chart. The medical record chart template master may store an item and category being included in each medical record chart. The care plan trigger master may store an associative relation between the medical record chart and a care plan. The medical data storage may store patient information, medical information and a record being written in a procedure performing a management of the medical record or the medical information.

The network 130 may include a wireless or wire communication network. Otherwise, network 130 may correspond to a data bus.

FIG. 2 is a block diagram of a medical information management apparatus. Other embodiments and configurations may also be provided.

FIG. 2 shows that the medical information management apparatus 110 may include an association registering unit 210, a medical record chart accessing unit 220, an association checking unit 230, an automatic input unit 240, a care plan generating unit 250 and a control unit 260. The medical information management apparatus 110 may cause specific information to be received and to be outputted from the user through the user terminal.

The association registering unit 210 may receive and register the association between the at least one item included in each of the plurality of the medical record charts by the user terminal to store the association in the database server 120. Each item may be independent of each of the medical record charts, and each item may be independently stored in a separate storage space of the database server 120. That is, an item A in a medical record chart 1 and an item A in a medical record chart 2 may be respectively stored in the separate storage space. In at least one embodiment, the at least one item may be stored in the item master of the database server 120.

In at least one embodiment, the plurality of medical record charts may correspond to a chart written during treating the patient and may include a chart being periodically written or being written at a specific situation. Each of the plurality of medical record charts may include at least one separate item. The item being included in the medical record chart may correspond to an item being written while treating the patient. For example, the item may correspond to a blood pressure, an oxygen (O₂) saturation, a temperature, a body part in a pain and a pain degree.

In at least one embodiment, the association registering unit 210 may receive, from the user terminal, and register the association between corresponding items for substantially same items of a plurality of items included in each of the plurality of medical record charts. For example, because {sex} in the medical record chart 1 and {gender} in the medical chart 2 correspond to substantially same items and a value for a corresponding item may be inputted as a male or a female, the user may register an association between the {sex} in the medical record chart 1 and the {gender} in the medical chart 2 through the user terminal, and the association registering unit 210 may store the registered association in the database server 120 through the user terminal.

In at least one embodiment, the association registering unit 210 may assign an identifier to the at least one item. When the plurality of the items are a same item, the association registering unit 210 may assign a same identifier for the plurality of items. For example, because the {sex} in the medical record chart 1 and the {gender} in the medical chart 2 are same items, each of identifiers {sex} and {gender} may be assigned as {sex: abc0123} and {gender: abc0123}.

In at least one embodiment, the association registering unit 210 may receive and register a sub-item for the at least one item, and the sub-item may be managed through the database server 120. When a value for a specific item is inputted, the sub-item may be an item being written in addition to the specific item and may correspond to an item for a following treating operation. For example, when {pimple/rash} is checked (or determined) while a medical record for {skin} is written, an additional check for the {skin} is required. Therefore, {location of pimple or rash} or {degree of pimple or rash} corresponding to an additional check item may be registered as the sub-item.

In at least one embodiment, the medical information management apparatus 110 may further include a sub-item automatic generating unit. The sub-item automatic generating unit may automatically generate the sub-item for a corresponding item when a value for the at least one item is inputted through the user terminal and a sub-item associated with the corresponding item exists in the database server 120. In at least one embodiment, the sub-item automatic generating unit may generate a main agent for generating and writing the sub-item. For example, the sub-item automatic generating unit may generate the main agent performing the corresponding item such as {degree of pimple or rash—head of nursing} with generating the {degree of pimple or rash}.

In at least one embodiment, the medical record chart accessing unit 220 may receive a definition for an item, sub category and category type included in each of the plurality of medical record charts and association between the item, sub category, category and the plurality of medical record charts from the user terminal and may store association information received from the user terminal in the medical record chart template master of the database server 120 by the item, category or medical record chart. The item may be included in the sub category, and the sub category may be included in the category so that one of the medical record chart may be formed by a formation of each of a plurality of categories. For example, the medical record chart may be formed with {medical record chart—admission assessment}, {category—transport information, vital sign, hearing}, {sub category of vital sign—blood pressure, O₂ sat, radial pulse, temperature} and {item of blood pressure—systolic BP, diastolic BP item}.

In at least one embodiment, a medical record chart template may be generated (or provided) by the user based on following procedures. The user may select a type of the medical record chart, select a category forming a corresponding medical record chart, select a sub category in each category and select an item in each sub category to generate the medical record chart.

The medical record chart accessing unit 220 may receive, from the user, a request for an access for a first medical record chart. In at least one embodiment, the medical record chart accessing unit 220 may be stored in the database server 120 to check (or determine) an access authority for at least one of a search, a writing, a deletion and a management. The access authority for the medical record chart may be differently set, by the user, for each of the search, the writing, the deletion and the management of the medical record chart. When the user requests an access for the first medical record chart, the medical record chart accessing unit 220 may check (or determine) whether a corresponding user has the access authority set at the first medical record chart.

The association checking unit 230 may check (or determine) whether at least one second item associated with the at least one first item in the first medical record chart exists based on an association between at least one item registered through the medical record chart accessing unit 220 to be stored in the item master of the database server 120. The at least one first item and the at least one second item associated with the at least one first item may be included in at least one of the plurality of medical record charts.

In at least one embodiment, the association checking unit 230 may check (or determine) whether a second item having a same identifier with an identifier of the first item exists based on the identifier of the at least one first item.

In at least one embodiment, the medical information management apparatus 110 may further include the automatic input unit 240. The automatic input unit 240 may receive a value inputted in the second item when the at least one second item associated with the at least one first item in the first medical record chart exists, so as to input a value of the second item to the value of the first item. Information for the specific item inputted from the user terminal may be stored in the medical data storage of the database server 120. The automatic input unit 240 may receive the value for the second item from the medical data storage to input the value of the second item to the value of the first item. For example, an item A of the medical record chart 1 may be associated with an item a of the medical record chart 2 and {x} is inputted at the item A of the medical record chart 1 when the item has {x} as the value.

In at least one embodiment, the automatic input unit 240 may check (or determine) whether the value being inputted to the second item is effective according to a user set. More specifically, the automatic input unit 240 may write a value of the second item to that of the first item for an item being written after periodically treating the patient or being unreliable after a specific time when a criterion predetermined by the user is satisfied. For example, when an effectiveness criterion for a value of the blood pressure and temperature item is set within three days and an item associated with the blood pressure and temperature item of the medical record chart 1 exists in the medical record chart 2, if the blood pressure and temperature item in the medical record chart 2 is written within three days from a time where the blood pressure and temperature item in the medical record chart 2, the automatic input unit 240 inputs a value of a corresponding item in the medical record chart 2 to a value of the corresponding item in the medical record chart 1 and if not, does not input that.

In at least one embodiment, when a value automatically inputted for the first item through the automatic input unit 240 is changed by the user terminal, the value of the second item associated with the first item may not be changed and the value of the first item may be changed. Additionally, when the at least one second item associated with the at least one first item does not exist, the value for the first item may be received from the user.

In at least one embodiment, the medical information management apparatus 110 may further include the care plan generating unit 250. The care plan generating unit 250 may generate (or provide) a care plan based on the value being inputted in the at least one item in the first medical record chart. The care plan may correspond to a plan for processing a personalized treatment according to a patient condition, and may include a range and problem of the care plan, goal, treating method and/or treatment operator.

In at least one embodiment, the association between the medical record chart and care plan may be received from the user terminal to be stored in the care plan trigger master, and the care plan generating unit 250 may automatically generate the care plan through a value being inputted in a specific medical record chart based on the association between the medical record chart and care plan stored in the care plan trigger master.

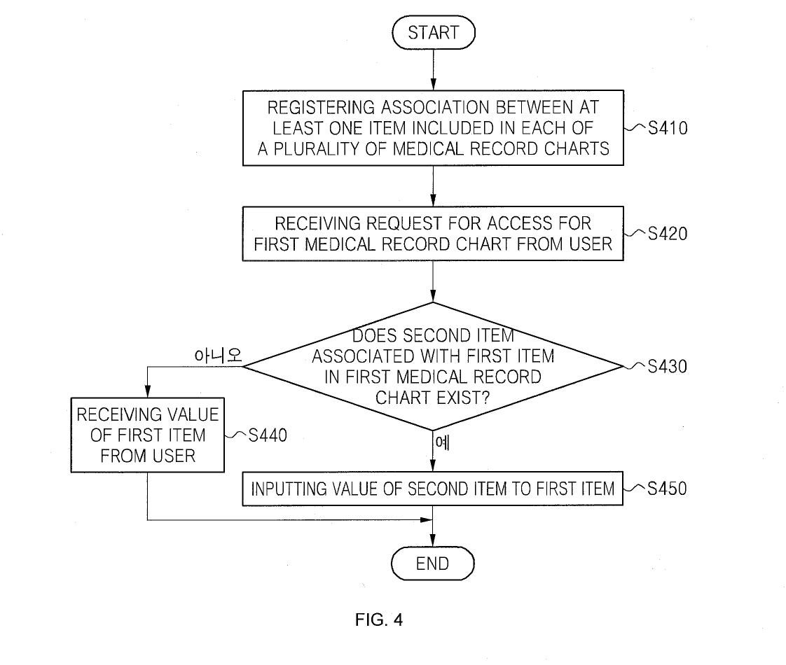

In at least one embodiment, when an association between a specific writing item included in the care plan with the at least one item in the first medical record chart is checked through the care plan trigger master, the care plan generating unit 250 may cause a writing item being predetermined by the user to be inputted to the specific writing item of the care plan. More specifically, when a specific value is inputted to the specific item of the medical record chart, the user may predetermine a written content being inputted to a specific writing item of the care plan and may associate the specific writing item of the care plan with the specific item. The written content for the specific writing item inputted by the user and association information may be stored in the database server 120. FIG. 4 relates to an example embodiment for a generation of the care plan.

The control unit 260 may control an operation and data flow of the association registering unit 210, the medical record chart accessing unit 220, the association checking unit 230, the automatic input unit 240 and the care plan generating unit 250.

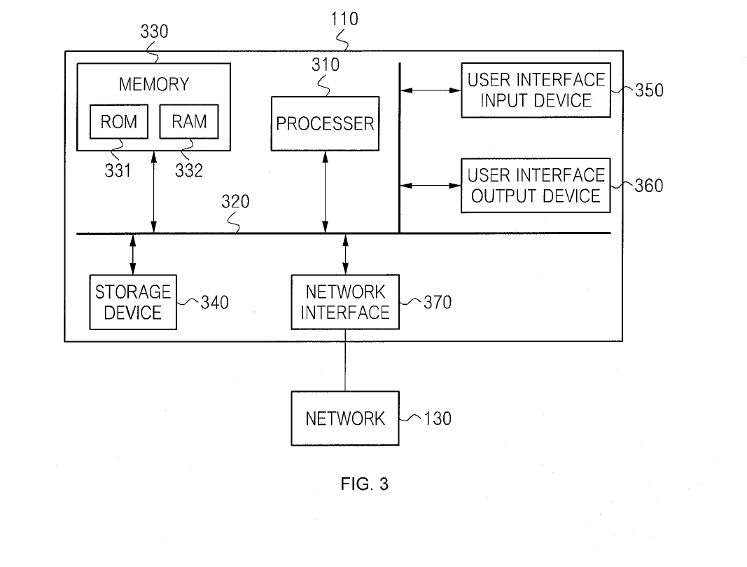

FIG. 3 is a diagram of a hardware configuration for a medical information management apparatus and a database server. Other embodiments and configurations may also be provided.

The medical information management apparatus 110 may include a processor 310 or a Central Processing Unit (CPU) communicating with various other components through a bus 320. The processor 310 may control an operation of the other components and execute medical information management with the other components. The processor 310 may be electrically connected with a memory 330 to manage medical information through commands stored in the memory 330 by the user request.

The medical information management apparatus 110 may include the memory and a storage device 340. The memory 330 may include a ROM (Read Only Memory) 331 and a RAM (Random Access Memory) 332. The memory 330 may correspond to a computer readable medium being transitory or non-transitory. The storage device 340 may correspond to a computer readable medium being non-transitory. At least one of the memory 330 and the storage device 340 may store a computer code including a command for the medical information management.

The medical information management apparatus 110 may include a network interface 370 for communicating with the network 130. The network interface 370 may set an environment transmitting information, data and signal between the medical information management apparatus 110 and the network 130. Referring to FIG. 1, because the medical information management apparatus 110 links with the database server 120 through the network 130, the medical information management apparatus 110 may include the information, data and signal for components of the medical record chart being used by the medical information management apparatus 110.

The user may communicate with the medical information management apparatus 110 through a user interface input unit 350 (e.g., a mouse, a trackball, a touch pad, a graphic tablet, a scanner, a barcode scanner for scanning a product barcode, a touch screen, a keyboard or a pointing device). The user interface input unit 350 may include all mechanism inputting information (e.g., a transaction) to the medical information management apparatus 110 or the network 130. In at least one embodiment, the user may directly input information being inputted or registered through the user terminal to the medical information management apparatus 110 through the user interface input unit 350.

The user may receive the information (e.g., the medical record chart) from the medical information management apparatus 110 through a user interface output device 360. For example, the user interface output device 360 may include a visual output device such as a display monitor. However, the user interface output device 360 may not be limited to the visual output device. The user interface output device 360 may include all mechanisms outputting information to the user, and may be connected with an output device such as an image output device or a speaker. In at least one embodiment, the user interface output device 360 may receive and output information being provided to the user terminal from the medical information management apparatus 110.

In at least one embodiment, a display screen may display information received from the medical information management apparatus 110 and may receive an input from the user. That is, the display screen may be implemented as the user interface input device 350 and the user interface output device 360.

Components of the medical information management apparatus 110 in FIG. 2 may be performed using components of the medical information management apparatus 110 in FIG. 3.

FIG. 4 is a flow chart showing a method of managing medical information being performed by the medical information management system of FIG. 1. Other embodiments, operations or orders of operations may also be provided.

The association registering unit 210 may receive and register the association between the at least one item being included in each of the plurality of medical record charts by the user terminal (Operation S410). In at least one embodiment, the association registering unit 210 may assign the identifier to the at least one item and may assign the same identifier to a substantially same item.

The medical record chart accessing unit 220 may receive, from the user, the request for the access for the first medical record chart (Operation S420). In at least one embodiment, an access authority may be set in each of plurality of the medical record charts, and the medical record chart accessing unit 220 may check (or determine) whether the user requesting the access has the access authority for a corresponding medical record chart.

The association checking unit 230 may check (or determine) whether the second item associated with the first item in the first medical record chart exists through the database server 120 (Operation S430). The first medical record chart may receive the access authority through the medical record chart accessing unit 220. In at least one embodiment, the second item may be included in the at least one medical record chart, and may check (or determine) whether the second item having the same identifier exists based on the identifier of the first item.

When an existence of the second item associated with the first item is checked (or determined) through the association checking unit 230, the automatic input unit 240 may input the value of the first item to the value of the second item (Operation S440). In at least one embodiment, the automatic input unit 240 may not input the value of the second item to the value of the first item based on effectiveness of the value of the second item. In another embodiment, when a nonexistence of the second item associated with the first item is checked (or determined) through the association checking unit 230, the value of the first item may be inputted by the user (Operation S450).

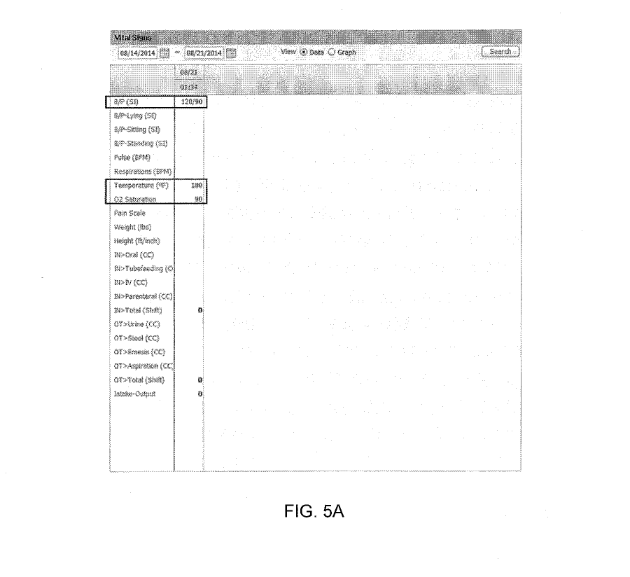

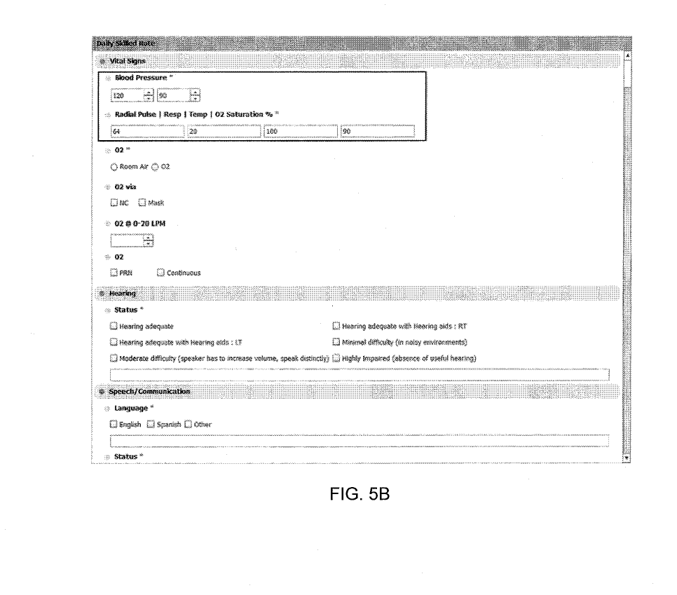

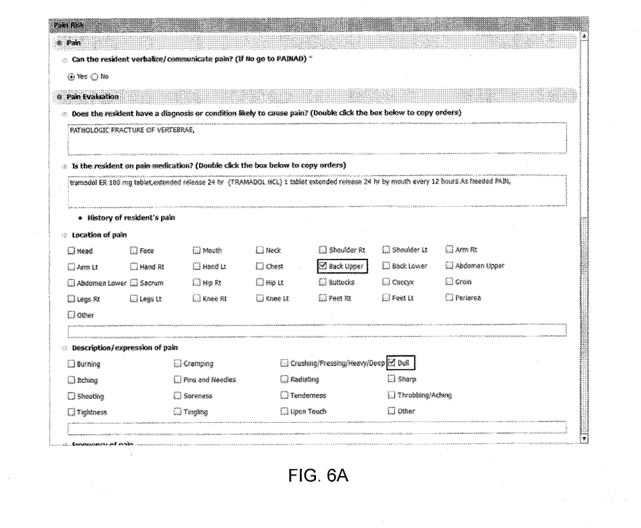

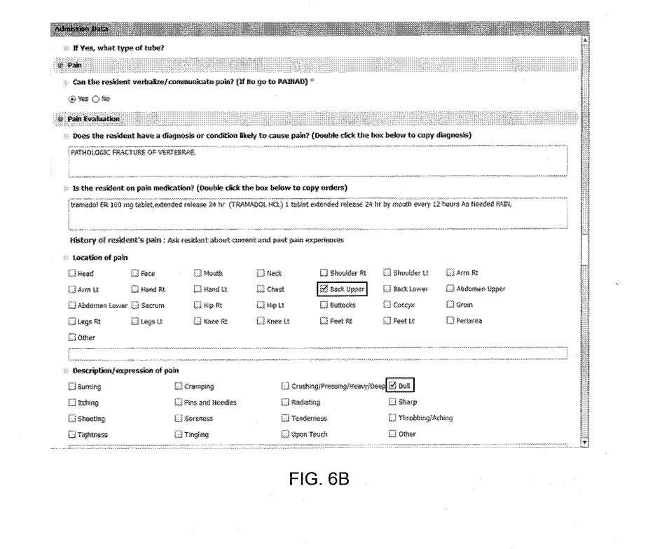

FIGS. 5A-5B and 6A-6B are example diagrams showing examples where a value is automatically inputted in an item of a medical record chart. Other examples may also be provided.

Referring to FIG. 5A, a value corresponding to {B/P, 120/90}, {Temperature, 100} and {O₂ Saturation, 90} for each of the B/P item, Temperature item and O₂ Saturation item may be inputted as the medical record chart for a vital sign.

FIG. 5B corresponds to an example when a value is inputted at the at least one item of a daily medical record chart.

More specifically, the association registering unit 210 may receive and register the association between at least one of the medical record chart for the vital sign and the at least one item of the daily medical record chart from the user terminal to store the association in the database server 120. That is, the association registering unit 210 may receive and register the association corresponding to {B/P, Blood Pressure}, {Temperature, Temp} and {O₂ Saturation, O₂ Saturation %} for the medical record chart for the vital sign and the daily medical record chart from the user to store in the database server 120.

The medical record chart accessing unit 220 may receive the request for the access for the daily medical record chart from the user and the association checking unit 230 may check (or determine) whether an item associated with the at least one item in the daily medical record chart through the database server 120. That is, the association checking unit 230 may check (or determine) whether an item associated with each of plurality of items (e.g., the Blood Pressure, Radial pulse, Temp, O₂ Saturation %, O₂, O₂ via) exists in the medical record chart for the vital sign.

Referring to a result for checking (or determining) through the association checking unit 230, when each of the Blood Pressure, Temp and O₂ Saturation % in the medical record chart for the vital sign is associated with the B/P, Temperature and O₂ Saturation in the daily medical record chart, a value inputted at the B/P item, Temperature item and O₂ Saturation item in the medical record chart for the vital sign may be inputted to a value of the Blood Pressure item, Temp item and O₂ Saturation % item in the daily medical record chart. That is, a value corresponding to {Blood Pressure, 120/90}, {Temp, 100} and {O₂ Saturation %, 90} may be automatically inputted to the value for the Blood Pressure item, Temp item and O₂ Saturation % item of the daily medical record chart.

In FIG. 6A, {Can the resident verbalize/communicate pain? Yes} is inputted at a Pain item of the medical record chart information and {Does the resident have a diagnosis or condition likely to cause pain?, written content 1}, {Is the resident on pain medication?, written content 2}, {Location of pain, Back Upper} and {Description/expression of pain, Dull} is inputted at a Pain evaluation item.

FIG. 6B corresponds to a medical record chart for Pain Risk and Pain and Pain Evaluation being included in the Pain Risk is an item associated with the medical record chart information of FIG. 6A so that a value for the Pain item and Pain Evaluation item of the medical record chart for the Pain Risk is automatically inputted to a value for a corresponding item of the medical record chart information. A detail procedure is same with FIG. 5A and FIG. 5B.

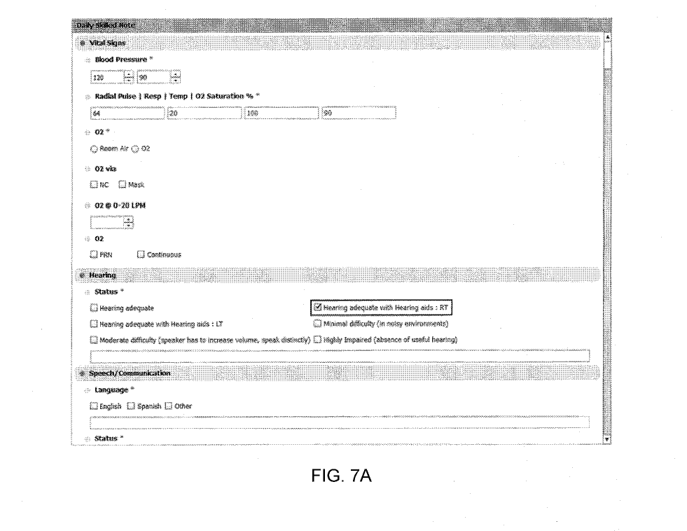

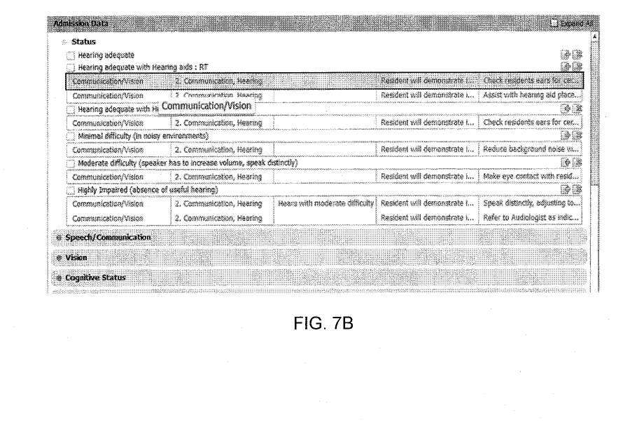

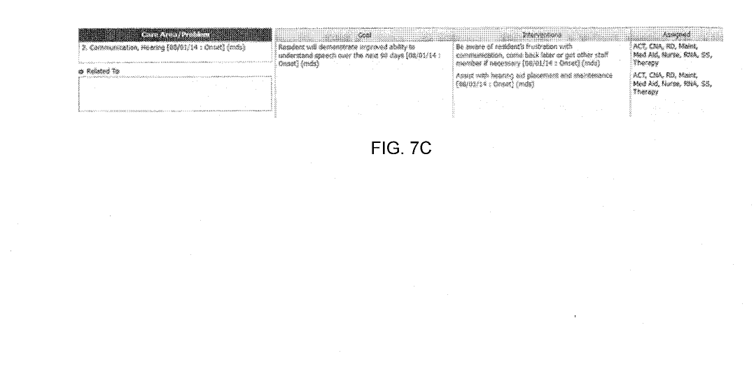

FIGS. 7A-7C are example diagrams showing a care plan being automatically generated. Other examples may also be provided.

FIG. 7A shows a {Hearing the adequate with Hearing aids:RT} of a Hearing-Status item is checked on the daily medical record chart.

FIG. 7B corresponds to a care plan trigger. When the association between the medical record chart and the care plan is defined by the user terminal and the specific item of the medical record chart is written by the user terminal, the care plan trigger may cause the care plan associated with the specific item to be automatically generated. FIG. 7B indicates that the user predetermines a written content automatically inputted in the care plan when it is checked at Hearing adequate with Hearing aids:RT of Status item of the medical record chart and each of the written content is automatically inputted at each of the written content corresponding to the range and problem of the care plan, goal, treating method and/or treatment operator.

FIG. 7C shows the care plan generated through the care plan generating unit 250. When it is checked at Hearing adequate with Hearing aids:RT of the Hearing Status item of the medical record chart, the care plan generating unit 250 may automatically input each of the range and problem of the care plan, goal, treating method and/or treatment operator based on a content predetermined through the care plan trigger. In at least one embodiment, a content not predetermined through the care plan trigger may be inputted by the user.

Embodiments may provide a method of managing medical information capable of automatically inputting a value for a corresponding item based on an association between items included in a medical record chart when the corresponding item is previously inputted to another medical record chart, so as to minimize a redundant input.

Embodiments may provide a method of managing medical information capable of ensuring a matching between medical records to decrease an error between the medical records and to prevent a generation of wrong information.

Embodiments may provide a method of managing medical information capable of automatically generating (or providing) a care plan based on a medical record.

In at least one embodiment, a method of managing medical information may include receiving, from a user, and registering an association between at least one item being included each of a plurality of medical record charts, a first item in a first medical record chart and a second item in a second medical chart. The method may also include receiving a request for an access to a first medical record chart from the user and checking (or determining) whether at least one second item associated with at least one first item in the first medical record chart exists among the plurality of medical record charts.

The each of the at least one item in each of the plurality of medical record charts may be independent from each other.

The receiving, from a user, and registering the association may include assigning an identifier to the at least one item.

The receiving, from a user, and registering the association may include assigning a same identifier to the at least one first and second items when the at least one first and second item is associated with each other.

The receiving, from a user, and registering the association may include registering a sub-item for the at least one item.

The method may further include automatically generating the sub-item for a corresponding item of the first medical record chart when a value for the at least one item is inputted and a sub-item for the inputted item exists.

The receiving of the request for an access may include checking an access authority for at least one of a search, a writing, a deletion and a management of the first medical record chart.

The method may further include receiving a value being inputted in the at least one second item when the at least one second item associated with the at the least one first item in the first medical record chart exists, so as to input a value of the at least one second item to the value of the at least one first item.

The receiving of the value being inputted in the at least one second item may include checking whether the value being inputted in the at least one second item is effective according to a user setting.

The method may further include generating a care plan based on the value being inputted in the at least one item in the first medical record chart.

The generating of the care plan may include inputting a specific written content predefined by the user when the specific writing item included in the care plan is associated with the at least one item in the first medical record chart.

In at least one embodiment, a medical information management system may include a processor, a memory including at least one storage area and a computer readable medium being non-transitory and including instructions causing the processor to perform a method of managing medical information when executed. The method may include receiving, from a user, and registering an association between at least one item being included in each of a plurality of medical record charts, a first item in a first medical record chart and a second item in a second medical chart being independent from each other. The method may include receiving a request for an access for a first medical record chart from the user and checking whether at least one second item associated with at least one first item in the first medical record chart exists, the at least one second item being included in the plurality of medical record charts.

The method may further include receiving a value being inputted in the at least one second item when the at least one second item associated with the at the least one first item in the first medical record chart exists to input a value of the at least one second item to the value of the at least one first item.

The method may further include generating a care plan based on the value being inputted in the at least one item in the first medical record chart.

In at least one embodiment, a machine-readable non-transitory medium may store a computer program for a method of managing medical information. The machine-readable non-transitory medium may have stored thereon machine-executable instructions for receiving, from a user, and registering an association between at least one item being included in each of a plurality of medical record charts, a first item in a first medical record chart and a second item in a second medical chart being independent from each other. The instructions may be further for receiving a request for an access for a first medical record chart from the user and checking whether at least one second item associated with at least one first item in the first medical record chart exists, the at least one second item being included in the plurality of medical record charts.

Embodiments may automatically input a value for a corresponding item based on an association between items included in a medical record chart when the corresponding item is previously inputted to another medical record chart to minimize a redundant input.

Embodiments may ensure a matching between medical records to decrease an error between the medical records and to prevent a generation of wrong information.

Embodiments may automatically generate a care plan based on a medical record.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of managing medical information, the method comprising:
receiving, from a user, and registering an association between at least one item in each of a plurality of medical record charts, a first item in a first medical record chart and a second item in a second medical chart;
receiving, from the user, a request for an access to a first medical record chart; and
determining whether at least one second item associated with at least one first item in the first medical record chart exists among the plurality of medical record charts.

2. The method of claim 1, wherein each of the at least one item in each of the plurality of medical record charts is independent form each other.

3. The method of claim 1, wherein the receiving and the registering of the association includes assigning an identifier to the at least one item.

4. The method of claim 3, wherein the receiving and the registering of the association includes assigning a same identifier to the at least one first and second items when the at least one first and second item are associated with each other.

5. The method of claim 1, wherein the receiving and the registering of the association includes registering a sub-item for the at least one item.

6. The method of claim 4, further comprising:
automatically generating the sub-item for a corresponding item of the first medical record chart when a value for the at least one item is inputted and a sub-item exists for the inputted item.

7. The method of claim 1, wherein receiving the request for the access includes determining an access authority for at least one of a search, a writing, a deletion and a management of the first medical record chart.

8. The method of claim 1, further comprising:
receiving a value being inputted in the at least one second item when the at least one second item associated with the at the least one first item in the first medical record chart exists to input to a value of the at least one second item to the value of the at least one first item.

9. The method of claim 8, wherein receiving the value being inputted in the at least one second item includes determining whether the value being inputted in the at least one second item is effective according to a user setting.

10. The method of claim 1, further comprising:
providing a care plan based on the value being inputted in the at least one item in the first medical record chart.

11. The method of claim 10, wherein providing the care plan includes inputting a specific written content predefined by the user when the specific writing item included in the care plan is associated with the at least one item in the first medical record chart.

12. The method of claim 1, wherein each of the plurality of medical record charts is set to an access authority for at least one of a search, a writing, a deletion and a management of a corresponding the medical record chart.

13. A medical information management system, the system comprising:
a processor;
a memory including at least one storage area; and
a non-transitory computer readable medium including instructions causing the processor to perform a method of managing medical information when executed, the method including:
receiving, from a user, and registering an association between at least one item included in each of a plurality of medical record charts, a first item in a first medical record chart and a second item in a second medical chart;
receiving, from the user, a request for an access to a first medical record chart; and
determining whether at least one second item associated with at least one first item in the first medical record chart exists among the plurality of medical record charts.

14. The system of claim 13, wherein the method further including:
receiving a value being inputted in the at least one second item when the at least one second item associated with the at the least one first item in the first medical record chart exists to input a value of the at least one second item to the value of the at least one first item.

15. The system of claim 14, wherein the receiving and the registering of the association includes assigning an identifier to the at least one item.

16. The system of claim 15, wherein the receiving and the registering of the association includes assigning a same identifier to the at least one first and second items when the at least one first and second item are associated with each other.

17. The system of claim 14, wherein the receiving and the registering of the association includes registering a sub-item for the at least one item.

18. The system of claim 15, wherein the method further including:
automatically generating the sub-item for a corresponding item of the first medical record chart when a value for the at least one item is inputted and a sub-item exists for the inputted item.

19. The system of claim 13, wherein the method further including:
providing a care plan based on the value being inputted in the at least one item in the first medical record chart.

20. A machine-readable non-transitory medium storing a computer program for a method of managing medical information, the machine-readable non-transitory medium having stored thereon machine-executable instructions for:
receiving, from a user, and registering an association between at least one item included in each of a plurality of medical record charts, a first item in a first medical record chart and a second item in a second medical chart;
receiving a request for an access for a first medical record chart from the user; and
determining whether at least one second item associated with at least one first item in the first medical record chart exists among the plurality of medical record charts.
